(19) United States
(12) Patent Application Publication
(10) Pub. No.: US 2008/0063353 A1
(43) Pub. Date: Mar. 13, 2008

(54) Hand-held mixed media recorder/player

(75) Inventor: James A. Howard, Birmingham, AL (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Doghouse Electronics LLC, New York, NY (US)

(21) Appl. No.: 11/519,437

(22) Filed: Sep. 11, 2006

(51) Int. Cl. H04N 5/91

(52) U.S. Cl. 386/46

(57) ABSTRACT

A mixed media recorder and player that stores video and/or audio data on a small sized, large capacity, removable, flash memory card, such as an SD card, is disclosed. The mixed media recorder and player is flat and pocket sized. Controls and connector terminals are located around the periphery of the mixed media recorder and player, allowing the display screen to cover substantially the entire face of one side of the mixed media recorder and player. The large capacity, removable, flash memory SD card has the capacity to store a full length feature movie.

### BACKGROUND

In addition to television sets displaying regularly scheduled programs, in recent years the development of video cassette tape recorders (VCRs) and, more recently, digital video disc (DVD) players and recorders have allowed traditional television sets to be used to display both pre-recorded programs, such as movies and television shows, and programs recorded from television signals for replay at a later time. In addition to traditional playing of pre-recorded DVDs on traditional television sets, portable, dedicated DVD players that include a DVD drive and a liquid crystal display (LCD) screen have been developed for playing pre-recorded DVDs. Miniaturization has also led to the development of hand-sized products having small internal hard drives and display screens that have the capacity to store the large amounts of data required to replay pre-recorded television-displayable programs, i.e., pre-recorded movies and television programs. The latter devices also have the capability to store photographs, i.e., still pictures, audio signals, i.e., songs, and other types of data. There are at least two major disadvantages to previously developed miniaturized devices having the capability to record and play television displayable programs and the like. Their display screens are relatively small, and they are relatively fragile.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A mixed media recorder and player that stores video and/or audio data on small-sized, large capacity, removable, flash memory cards, such as SD cards suitable for storing full length feature movies, television programs, and the like, is disclosed. The mixed media recorder and player is flat, and, preferably, pocket sized. Controls and connectors are located around the periphery of the mixed media recorder and player, allowing the display screen to cover substantially the entire face of one side of the mixed media recorder and player.

The mixed media recorder and player is connectable to various types of media sources, including, but not limited, to traditional television sets, VCRs, DVD players, DVD players and recorders, CD players and recorders, FM radios, and computers, for example, to allow various types of video and/or audio data to be stored on a flash memory card installed in the mixed media recorder and player. Preferably, the flash memory cards have a two gigabyte or greater capacity, which is sufficient to store at least one full length feature movie. Because the flash memory cards are removable, the amount of data storage memory is, in essence, infinite, as compared to a hard drive, which has a maximum capacity. Further, a mixed media player and recorder that employs flash memory cards rather than a hard drive is more robust, i.e., less likely to be damaged when dropped, for example, than a mixed media recorder and player that includes a small internal hard drive. In addition, flash memory card storage media increase the life of batteries when compared to devices employing small internal hard drives.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an exemplary environment in which a hand-held mixed media recorder and player formed in accordance with the invention is likely to be used;

FIG. 2 is an isometric view of an exemplary embodiment of a hand-held mixed media player and recorder formed in accordance with the invention;

FIG. 3 is an isometric view from another perspective of the hand-held mixed media recorder and player illustrated in FIG. 2; and

FIG. 4 is an exemplary block diagram of the functional elements of the exemplary hand-held mixed-media player and recorder illustrated in FIGS. 2 and 3.

### DETAILED DESCRIPTION

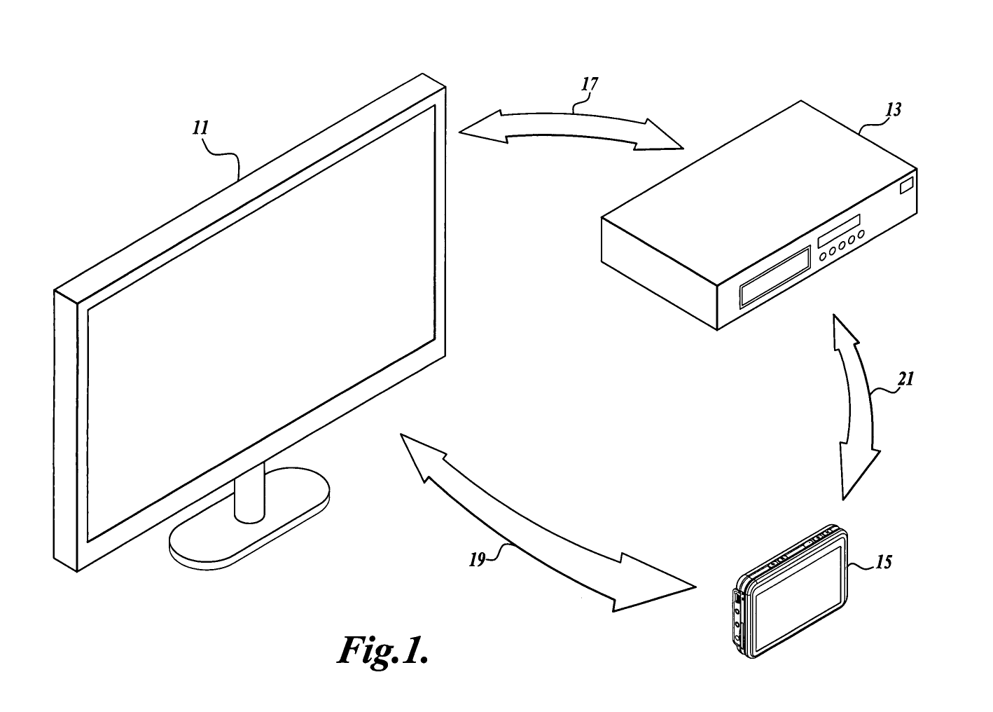

FIG. 1 includes a conventional television set 11, a media player 13 and a hand-held mixed media recorder and player 15, formed in accordance with the invention. For illustrative purposes only, the television set 11 is depicted as a flat panel television, such as a liquid crystal display (LCD) or plasma television. As will be readily appreciated by those skilled in the art and others, the television set 11 could also take the form of a conventional cathode ray tube (CRT) television set.

The media player 13 can take on a variety of forms. The media player could be a conventional video cassette tape recorder (VCR), a DVD player, a DVD player and recorder, a combination VCR and DVD player, a combination VCR and DVD player and recorder, or a combination player and recorder that includes a hard drive for storing television programs plus a VCR and/or a DVD player and recorder, or simply a hard drive, for example. As illustrated by a first arrow 17, the television set 11 is connectable to the media player 13 using any of several well-known connections such as RCA jacks, shielded cable, etc. Not shown in FIG. 1 is a television signal source, such as a television antenna, a satellite antenna, or a cable input.

FIG. 1 also illustrates by second and third arrows 19 and 21, respectively, that the hand-held mixed media recorder and player 15 can be connected to the television set 11 or the media player 13. Various types of connections well known to those skilled in the art and described to some degree below can be used to connect the hand-held mixed media recorder and player 15 to the television set 19 and/or the media player 13.

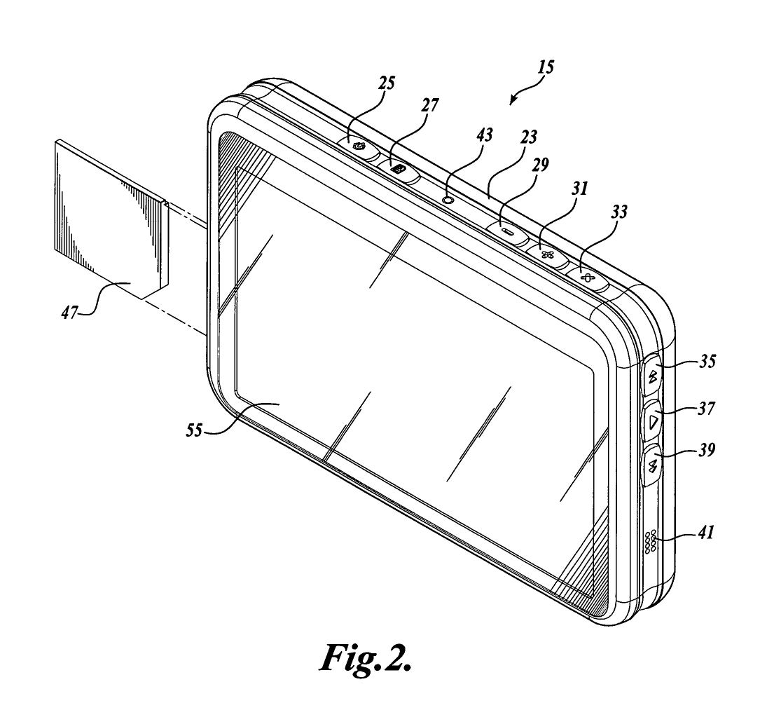

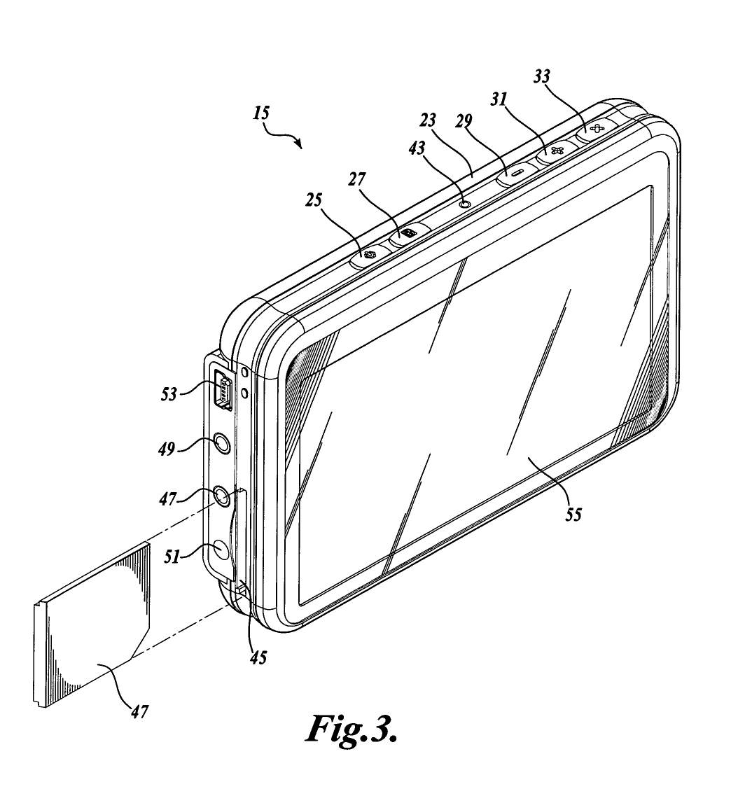

FIGS. 2 and 3 illustrate in more detail an exemplary embodiment of a hand-held mixed media player and recorder 15, formed in accordance with the invention, suitable for use in the exemplary environment illustrated in FIG. 1. The hand-held mixed media recorder and player illustrated in FIGS. 2 and 3 comprises a relatively flat right-rectangular parallelepiped housing 23 having curved edges. Located along one or more of the edges of the housing 23 are a plurality of control buttons, including, but not limited to, a power button 25, a menu/TV button 27, a volume decrease button 29, a volume increase button 31, an escape button 33, an up button 35, a play button 37, and a down button 39. In the illustrated embodiment with respect to the hereinafter display screen orientation, the power, menu/TV, volume decrease, volume increase, and escape buttons 25, 27, 29, 31, and 33 are located along the top edge of the housing 23. The up, play, and down buttons 35, 37, and 39 are located along the right edge.

As is conventional, the power button 25 turns the hand-held mixed media recorder and player 15 on and off. The menu/TV 27 button controls various operations depending on whether a menu is displayed on the hereinafter described display screen or a TV signal (either stored or external) causes an image to be displayed in the manner hereinafter described. The volume decrease and increase buttons 29 and 31, as is conventional, control the volume applied to earphones (not shown) or a speaker 41, also located along the right edge of the housing 23 in the illustrated embodiment. If desired, the hand-held, mixed media recorder and player 15 may include a microphone 43, shown as located along the top edge of the housing 23 in the illustrated embodiment.

As is conventional, the escape button 33 provides a return to a previous state. For example, when a menu is being displayed, actuation of this escape button may switch the menu display to the next upper level of the menu. The up and down buttons 35 and 39, in a conventional manner, control advance and back-up menu actions. More specifically, for example, in the case of an array of icons, the up and down buttons control movement of the icon focus, normally highlighting of the selected icons. Actuation of up button 35 causes highlighting to advance to the next icon (or list item) and actuation of the down button causes highlighting to back-up to the previous icon (or list item). The play button 37 controls the selection of selected (highlighted) icon (or list item).

While the power, menu, volume increase, volume decrease, and escape buttons and the microphone are depicted in FIGS. 2 and 3 as located along the upper edge of the hand-held mixed media recorder/player 15, and the up and down and play buttons are located along the right edge, obviously these locations are for illustration purposes only and should not be construed as limiting since any of the buttons can be placed in other locations along the same or different edges of the housing 23.

Located along the left edge of the housing 23 in the exemplary embodiment illustrated in FIGS. 2 and 3 is a slot 45 suitable for receiving a removable, flash memory card, such as a large capacity Secure Digital (SD) card 47. As will be readily appreciated by those skilled in the art, contemporary SD flash memory cards are currently available in sizes larger than two gigabytes (2 GB). A two gigabyte SD flash memory card can store several hours of TV playable audio/video programs, i.e., several hours of movies and television programs or shows. In addition to storing TV playable programs, SD cards can store photographs, songs, etc. As well known to those skilled in the art, SD cards have been conventionally used in digital cameras to store still photographs, a short sequence of still photographs, and, in some digital cameras, audio.

In addition to the slot 45 for receiving an SD card 47, the left edge of the housing 23 of the exemplary hand-held mixed media recorder and player 15 illustrated in FIGS. 2 and 3 also includes an audio and video (A/V) input terminal 47, an audio and video (A/V) output terminal 49, a power terminal 51, and a computer terminal 53 suitable for connection to, preferably, the USB port of a personal computer (PC). While the SD card slot 45 and the A/V input, A/V output, power, and computer terminals 47, 49, 41, and 53 are illustrated all on the left edge of the housing 23, this location should be construed as exemplary and not limiting. Obviously, these terminals could be located along different edges of the housing, or intermixed with the previously described buttons. Preferably, the A/V input and A/V output terminals 47 and 49 are three element pin connector terminals, one element for video, one element for left audio channel, and the other element for right audio channel.

One of the faces of the housing 23 of the hand-held media recorder and player 15 is substantially entirely covered by an LCD screen 55. Because the LCD screen 55 covers substantially the entire area of one of the faces of the housing 23, a large display region is provided. More specifically, because the various control buttons and connectors are located along the edges of the housing 23, substantially the entire area of one of the faces of the housing is available to be used as a video display region. Preferably, the LCD screen is a TFT real color LCD screen.

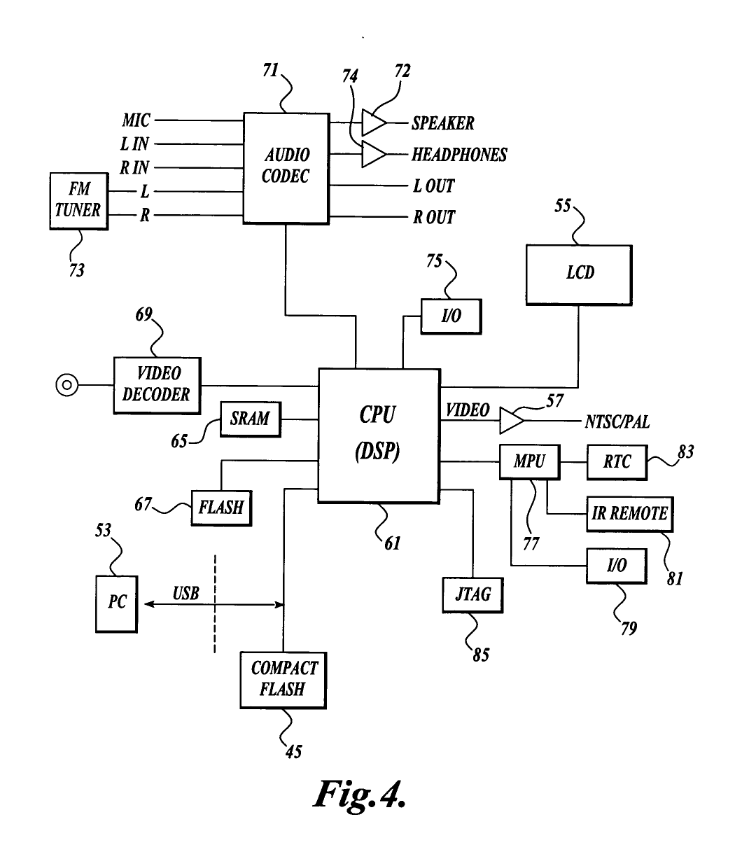

FIG. 4 is a block diagram of the various electronic components included in the exemplary hand-held mixed media recorder and player 15 illustrated in FIGS. 2 and 3 and described above. More specifically, FIG. 4 includes a central processing unit (CPU) 61, preferably in the form of a digital signal processor (DSP). The compact flash slot 45 that receives the SD card 47 is connected to the CPU 61, as is the PC terminal 53. In addition to the CPU, FIG. 4 includes random access memory preferably in the form of a static random access memory (SRAM) 65 and permanent memory, preferably in the form of flash memory 67. The flash memory 67 stores the operating system that controls the operation of the CPU, and the SRAM is used to provide temporary storage. A video decoder 69 is also illustrated as connected to the CPU. The video decoder receives video input signals from the A/V input terminal 47.

FIG. 4 also includes an audio coder/decoder (CODEC) 71. The audio CODEC can receive input from a variety of sources, including the microphone (MIC) 43, the left (L IN) and right (R IN) channels of the A/V input terminal 47, or the left and right channels of an FM tuner 73, also included in the hand-held media recorder and player 15. The audio CODEC generates an audio output that is applied to the speaker 41 via a suitable output amplifier 72 or to the earphones (not shown) via another suitable output amplifier 74. The audio CODEC output is also applied to the left (L OUT) and right (R OUT) channels of the A/V output terminal 49. The audio CODEC is controlled by the CPU 61.

An input/output circuit 75 that receives control signals created by the operation of the various buttons of the hand-held media recorder and player 15 illustrated in FIGS. 2 and 3 and described above is also connected to the CPU. The CPU 61 is connected to the LCD screen 55 and to a video amplifier 57 that amplifies the video output signals generated by the hand-held media recorder and player 15 for application to other devices via the A/V output terminal 49. The output can be in any suitable format, including, but not limited to, NTSC or PAL. If desired, some of the control signals created by the operation of the buttons may be applied to the CPU 61 via a microprocessing unit (MPU) 77. The MPU may also receive infrared (IR) remote control signals and real time clock signals. More specifically, the control signals produced by the operation of the buttons are applied to the MPU via an I/O circuit 79. The IR remote control signals are applied to the MPU via an IR remote sensor 81 and the real time clock signals as applied to the MPU via an RJC sensor 83. Finally, the DSP CPU 61 is programmable via a JTAG programming input 85.

As will be readily appreciated by those skilled in the art and others from the foregoing description, the invention provides a hand-held media recorder and player ideally suited for use in recording and playing television programs and movies. In addition to playing recorded television programs and movies on the hand-held media recorder and player, they can also be displayed on other display equipment, such as a conventional television set. Storing programs and movies on a non-destructive medium, i.e., a medium such as a large capacity, removable SD card, creates a robust, albeit small, media recorder and player having improved battery life. Because the controls and terminals are located along the edge of the housing of the hand-held media recorder and player, substantially the entire face of the housing can be used as a display screen. As a result, the display region is maximized. The use of large capacity, removable SD-cards allows, in essence, an infinite amount of memory to be used to store television programs and movies as well as other forms of audio and/or video data, such as photographs and songs, for example.

While the invention is ideally suited for implementation in hand-held sized products, such as products having a length of 3.6 to 4.125 inches, a height of 2.75 inches, and a depth of 0.60 inches, to record and play television programs and movies, for example, and will likely find most use therein, certain aspects of the invention, such as the use of large capacity flash memory cards 47 to record television shows and movies as well as other media, and/or all of the control and terminal connections located along edges of the housing 23 can be employed in other sized devices designed to record and play movies and television programs, and other type of media. Hence, it should be understood that within the scope of the appended claims, certain aspects of the herein discussed invention can be embodied in other sized devices.

While illustrative embodiments have been illustrated and described, it will be appreciated that various changes can be made therein without departing from the spirit and scope of the invention.

1. A mixed media recorder/player comprising:
a flat housing having a display area that encompasses substantially the entire face of one side of the housing, the edge of the flat housing surrounding the display area; and
a plurality of control buttons located in the edge of the flat housing.

2. A mixed media recorder/player as claimed in claim 1, wherein the flat housing is hand sized.

3. A mixed media recorder/player as claimed in claim 1, wherein the flat housing has a length dimension lying in the range of approximately 3.60 inches to approximately 4.125 inches, a height dimension of approximately 2.75 inches, and a thickness of approximately 0.60 inches.

4. A mixed media recorder/player as claimed in claim 1, also including a plurality of electrical connections located along the edge of the flat housing.

5. A mixed media recorder/player as claimed in claim 1, including a slot located along the edge of the flat housing suitable for receiving a flash memory card.

6. A mixed media recorder/player as claimed in claim 4, including a flash memory card.

7. A mixed media recorder/player as claimed in claim 6, wherein the flash memory card is a high capacity flash memory card.

8. A mixed media recorder/player as claimed in claim 7, wherein the capacity of the flash memory card is at least two gigabytes.

9. A mixed media recorder/player as claimed in claim 6, wherein the flash memory card is a secure digital (SD) card.

10. A mixed media recorder/player as claimed in claim 9, wherein the SD card is a high capacity SD card.

11. A mixed media recorder/player as claimed in claim 10, wherein the capacity of the SD card is at least two gigabytes.

12. A mixed media recorder/player comprising:
a flat housing having a display area that encompasses substantially the entire face of one side of the housing;
a slot in one edge of the housing suitable for receiving a flash memory card; and
a flash memory card installed in the slot in the housing.

13. A mixed media recorder/player as claimed in claim 12, wherein the flash memory card is a high capacity flash memory card.

14. A mixed media recorder/player as claimed in claim 13, wherein the capacity of the flash memory card is at least two gigabytes.

15. A mixed media recorder/player as claimed in claim 12, wherein the flash memory card is a secure digital (SD) card.

16. A mixed media recorder/player as claimed in claim 15, wherein the SD card is a high capacity SD card.

17. A mixed media recorder/player as claimed in claim 16, wherein the capacity of the SD card is at least two gigabytes.

18. A mixed media recorder/player as claimed in claim 11, wherein the flash memory card stores a full length feature movie.

19. A mixed media recorder/player as claimed in claim 11, wherein the flat housing is hand sized.
